(19) United States
(12) Patent Application Publication
(10) Pub. No.: US 2019/0308305 A1
(43) Pub. Date: Oct. 10, 2019

(54) Spike Setting Tool

(71) Applicant: John E. Price, Green River, WY (US)

(72) Inventor: John E. Price, Green River, WY (US)

(21) Appl. No.: 16/376,822

(22) Filed: Apr. 5, 2019

Related U.S. Application Data
(60) Provisional application No. 62/654,165, filed on Apr. 6, 2018.

(51) Int. Cl. B25D 1/16; B25D 1/04; E01B 29/26

(52) U.S. Cl. CPC B25D 1/16; E01B 9/06; E01B 29/26; B25D 1/04

(57) ABSTRACT

A spike setting tool with an improved ram-rod structure may feature a pronged fork at a distal end to hold spikes in place while the user actuates a ram-rod to set the spikes. A magnet may also be provided to aid in the picking up of spikes for setting in the fork.

### CROSS-REFERENCES TO RELATED APPLICATIONS

This Application claims priority to prior filed U.S. Provisional Application No. 62/654,165, filed Apr. 6, 2018, and incorporates the same by reference in its entirety.

### FIELD OF THE INVENTION

The present invention relates to the field of hand tools and more particularly relates to a hammer-type tool used for setting railroad spikes by a single person.

### BACKGROUND OF THE INVENTION

Railroads have been in use for about 200 years and have become a primary means of transporting cargo and people across continents. However, railroads need a continuous rail track from a train's start to destination. As such there are currently about 140,000 miles of railroad track in use in the United States alone. These tracks frequently need maintained and repaired—often by removing one or two rails, repairing an area, and replacing those one or two rails. Railroad spikes are frequently reused and just placed on the ground by the workers after the rail is removed. Currently, replacing such a small length of track is a manual operation—completed by workers who pick up and then hold a railroad spike on the rail and then swing a sledgehammer which usually weighs 8-10 lbs. (3.6-4.5 kg) to set the spike. Once set, a hydraulic driver typically finishes driving the spike. This current state of the art presents a real risk to the individual setting the spike as an inaccurate swing by the hammer operator can place the individual's hands or other body parts in jeopardy. Inaccurate swings also can cause spikes to fly away from the individual, putting others in jeopardy. A tool which could eliminate these risks and increase efficiency would be welcome in the trade.

The present invention is a driving tool used to pick up, hold, and set railroad spikes in advance of a hydraulic driver. The tool presents a ram rod contained within a pipe serving as a holder. A fork at the end of the pipe secures and holds the spike in position while a magnetic head allows for a single individual to gather individual spikes, place them on the fork, and set them in position in preparation for final driving. As the positioning of the spikes relative to the tool is uniform, the chance of errant strikes is lessened. The worker also does not have to bend down to pick up and set the spikes and can do so with no aid from other individuals. The present invention represents a departure from the prior art in that the tool of the present invention allows for a single individual to perform a repetitive and risky job more efficiently and with reduced risk to the individual and others.

### SUMMARY OF THE INVENTION

In view of the foregoing disadvantages inherent in the known system for setting railroad spikes, an improved tool may provide a single operator the ability to set railroad spikes in a uniform and efficient manner. Such a tool should meet the following objectives: portable, rugged in construction, relatively inexpensive, and capable of securely holding spikes in an upright position before driving them into the ground or other substrate. As such, a new and improved tool may comprise a ram-rod construction with a plurality of tines at a distal end in order to accomplish these objectives.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a spike setting tool.

FIG. 2 is a partial bottom perspective view of the spike setting tool of FIG. 1.

FIG. 3 is a sectional view of the spike setting tool, taken along line III-Ill of FIG. 2.

FIG. 4 is a perspective view of an individual using the spike setting tool of FIG. 1 to pick up a spike.

FIG. 5 is a perspective view of the head of the spike setting tool of FIG. 4.

FIG. 6 is a perspective view of the individual of FIG. 4 setting the picked-up spike in the spike setting tool.

FIG. 7 is a partial sectional view of the head of the spike setting tool of FIG. 6.

FIG. 8 is a perspective view of the individual of FIG. 6, engaging in a driving operation by preparing to drive the spike into a railroad tie.

FIG. 9 is a perspective view of the individual of FIG. 8, executing the driving operation by driving the spike into the railroad tie.

FIG. 10 is a perspective view of the spike and railroad tie of FIG. 9, after the driving operation of FIGS. 8 and 9.

### DETAILED DESCRIPTION OF THE PREFERRED EMBODIMENT

With reference now to the drawings, a preferred embodiment of the spike setting tool is herein described. It should be noted that the articles “a”, “an”, and “the”, as used in this specification, include plural referents unless the content clearly dictates otherwise.

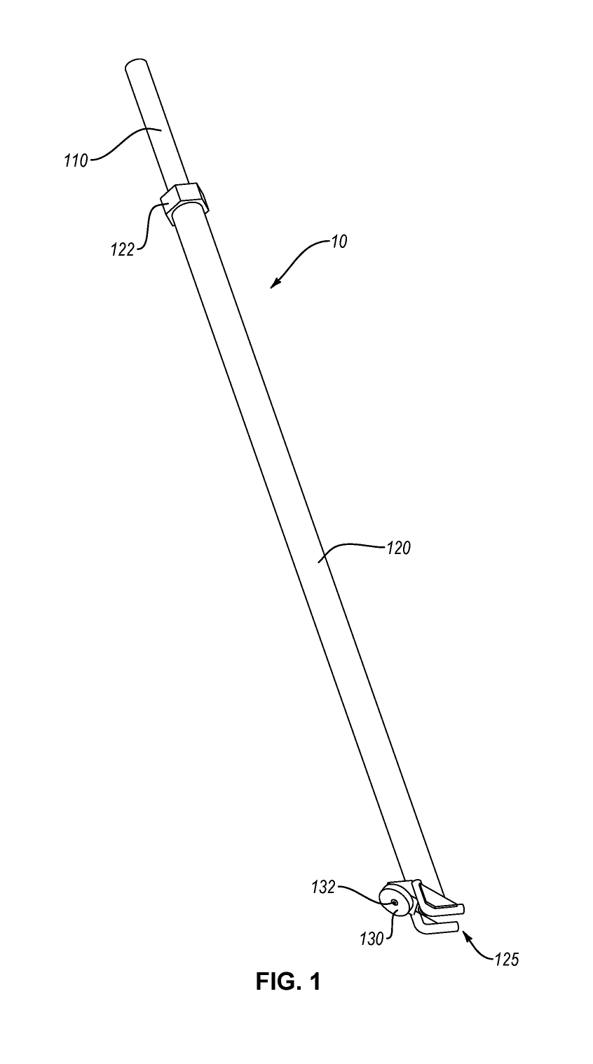

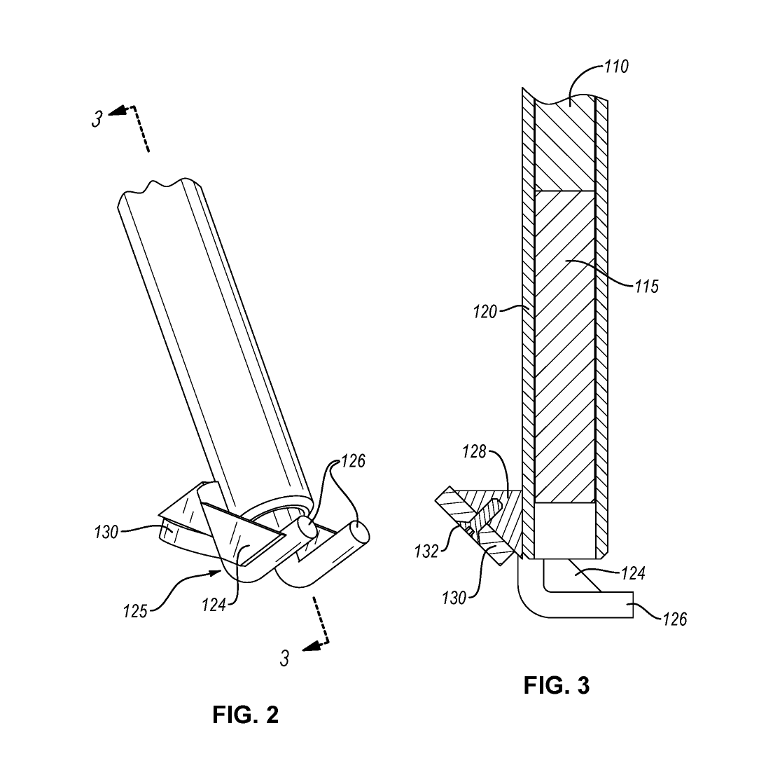

With reference to FIGS. 1-3, the spike setting tool 10 has two main components: a ram-rod 110 and a containment pipe 120. The ram-rod 110 may be as simple as a steel rod with or without a slightly larger head 115. In the preferred embodiment, this steel rod could be ⅞″ (2.2 cm) standard stock cold rolled steel and the head a slightly larger 1″ rod that are welded together, though they may be of the same diameter as is shown in the figures. Head 115 and rod 110 may also have the same diameter and have any ratio of length of one to the other so long as the head 115 is adequate for its purpose and the rod 110 may be used to sufficiently actuate the head 115. Ideally, the head 115 should be hard surfaced or treated in any way that would make it impact resistant. The dual construction of the rod 110 and head 115 allows for an effective tool to be made at a lesser cost. For the described ram-rod 110, the containment pipe 120 may be a 1″ (2.5 cm) inner diameter iron pipe with a top nut 122 secured thereon. At the bottom of the pipe 120, by head 115, a fork interface (shown best in FIG. 3) 125 may be constructed using two smaller rods 126 fastened on either side of the iron pipe 120 as tines. Each tine 126 could be about 5/16″ (0.8 cm) in diameter and 3″ (7.6 cm) long, spaced about ¾″ (1.9 cm) apart and bent at a right angle. Each tine 126 may be reinforced by a gusset 124, with both tines 126 and gussets 124 welded directly to the containment pipe 120 and each other. Overall, the length of the ram-rod 110 should be about 45″ (114.3), including the head 115, while the pipe 120 should be about 36″ (91.5 cm) with the tines 126 extending so their top edge is about ½″ (1.2 cm) beneath the bottom edge of the pipe 120. These measurements and dimensions detailed above should create an efficient tool for use with what are now considered standard railroad spikes in the United States at the time of filing and for use by average to larger-sized men. It should be readily understood that the dimensions may be altered to create different sized tools to receive different sized spikes or accommodate differently sized individuals.

A magnet 130 may be added to the tool for added utility and convenience. A mounting block 128 may be provided opposite the fork interface 125 and serve as a mount for magnet 130. Ideally, magnet 130 would be mounted slightly above and behind the fork interface 125 and angled back at about a 45° angle from the containment pipe 20. Any attachment method may be used, but the simplest would probably utilizing a bolt 132 to secure the magnet 130 to the block. Ideally, a 70 lb force (311.4 N) magnet or similar would be used.

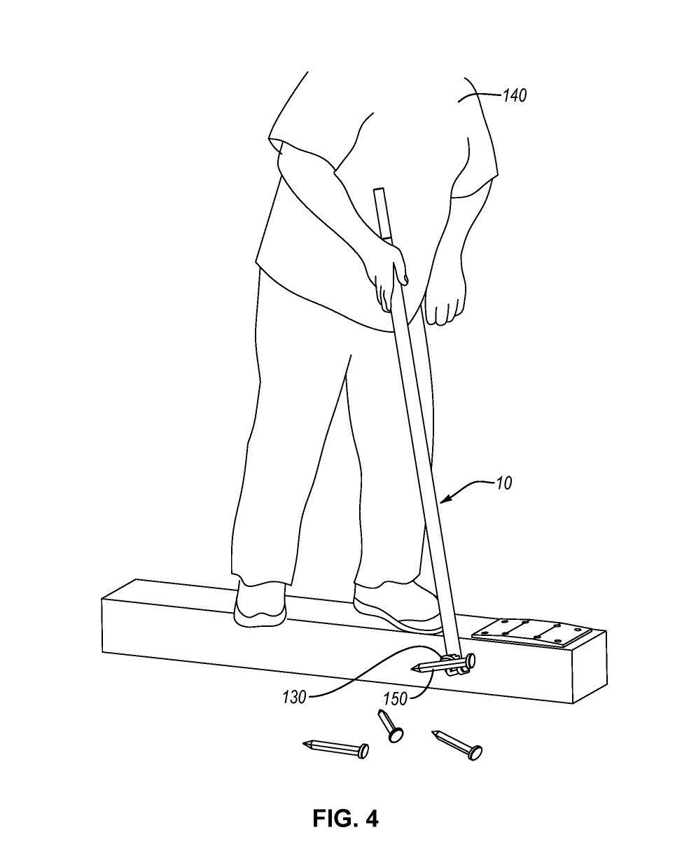

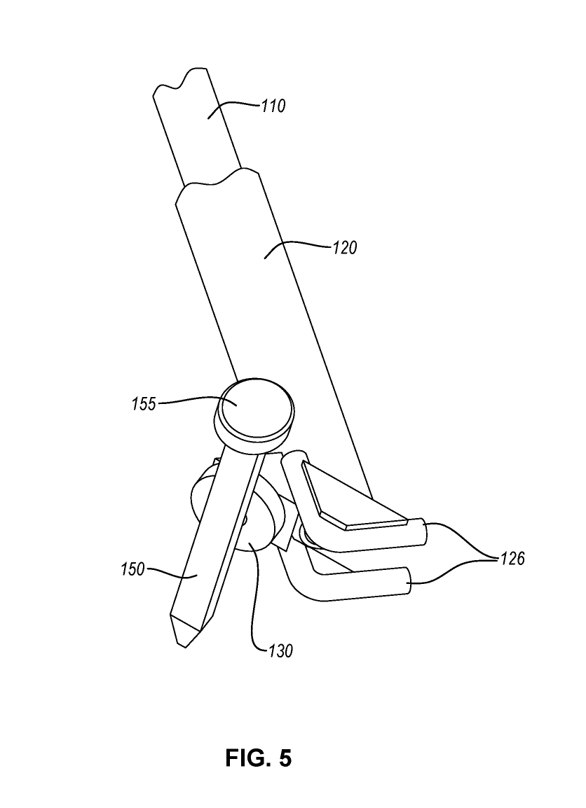

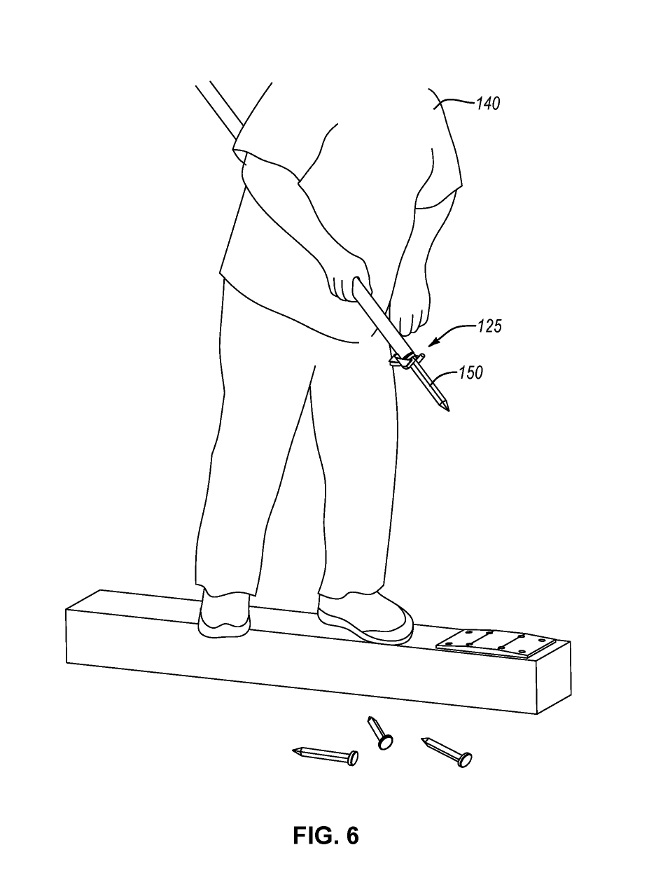

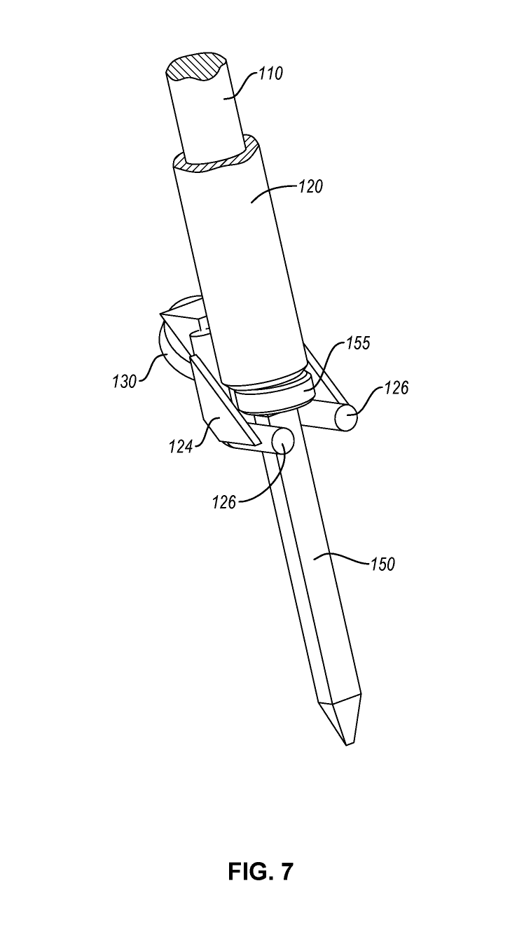

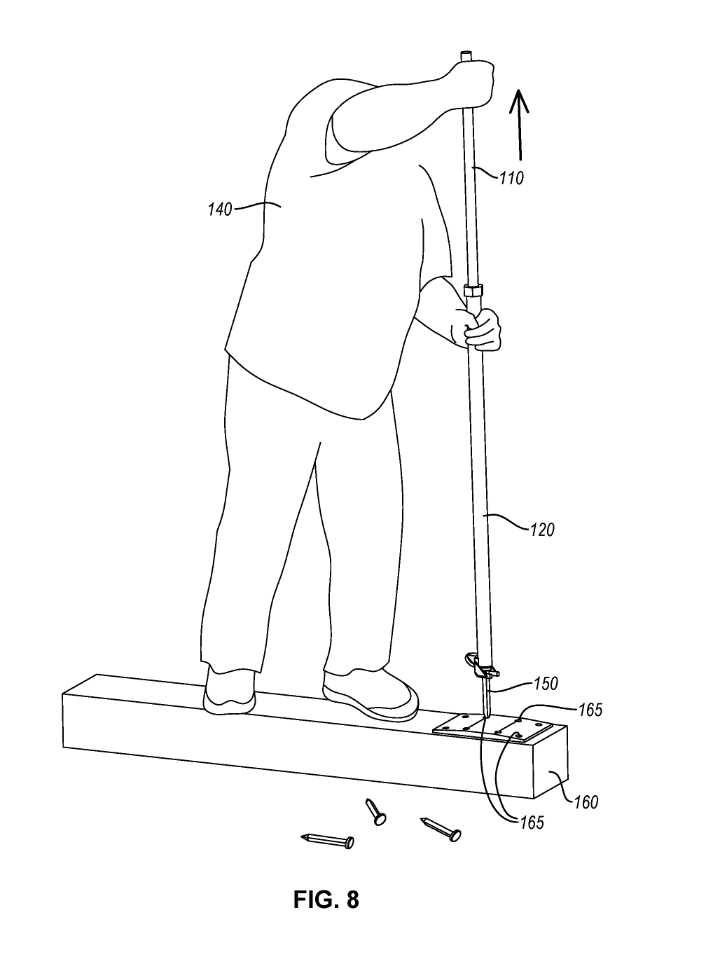

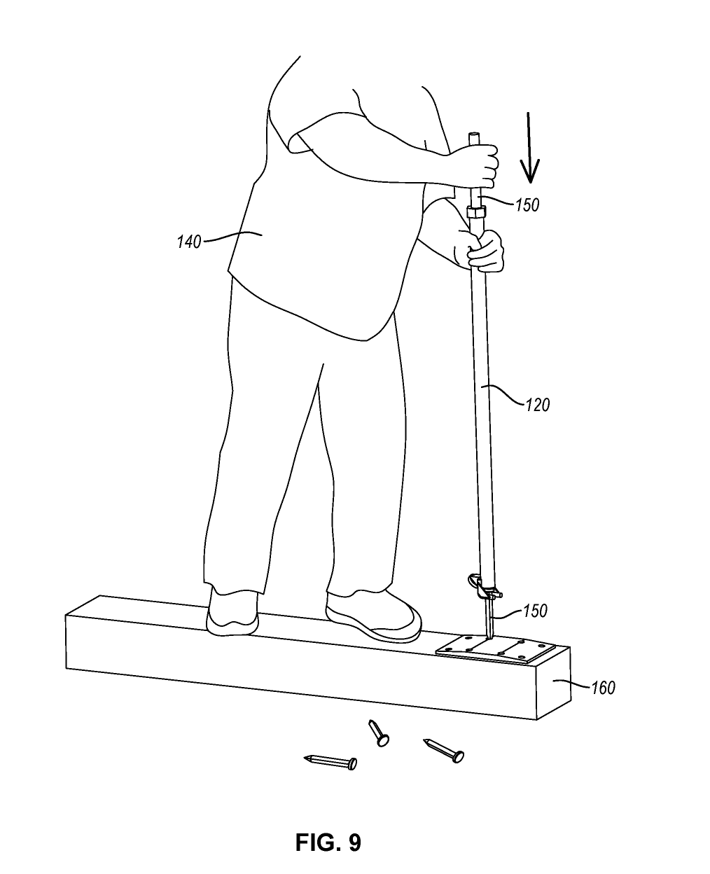

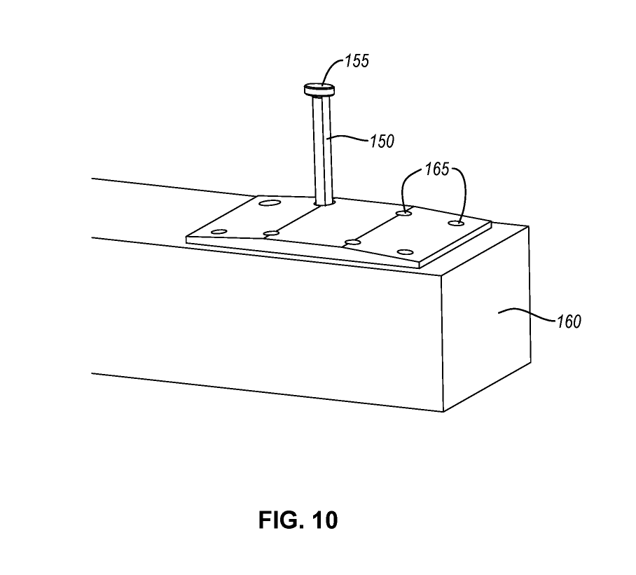

In use, a single operator 140 may walk along a rail and use the magnet 130 to pick up a useful spike 150 (FIGS. 4 and 5). The magnet 130 should have adequate strength to hold the spike 150, but not so much that the operator cannot remove it from the magnet 130. After removing the spike 150 from magnet 130, the operator 140 sets the spike 150 in the fork interface 125 (FIGS. 6 and 7), between the tines 126 so that the head of the spike 155 rests underneath the head of ram-rod 110. The spike 150 is then in a generally straight orientation with respect to the tool and pointing downwards. The operator 140 then positions the spike 150 into one of the pre-formed holes 165 in the rail 160 and then actuates the ram-rod 110 until the spike 150 is set in the hole (FIGS. 8 and 9). The operator 140 then unhooks the fork interface 125 from the spike head 155 and moves to the next hole. This leaves the spike 150 ready for final hammering to finish the job. (FIG. 10). It should be remembered that the purpose of the tool is only to set spikes into the rail, not fully hammer them into position.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A spike setting tool comprising:
a cylindrical ram-rod with two ends, encompassed by a tubular casing;
two prongs extending downward from the tubular casing, said prongs bending to extend in a forward direction to form two tines of a fork interface;
a support block rearward of the fork interface on the casing;
a magnet located on a lower surface of the support block so that it is behind the fork interface.

2. The spike setting tool of claim 1, the cylindrical ram rod further comprising a hardened head.

3. The spike setting tool of claim 1, the support block holding the magnet at about a 45° angle to the tubular casing.

4. The spike setting tool of claim 1, the two prongs being bent at about a 90° angle and a portion of which resides under the tubular casing.
